(19) United States
(12) Patent Application Publication
(10) Pub. No.: US 2009/0147374 A1
(43) Pub. Date: Jun. 11, 2009

(54) Rear focusing zoom lens

(76) Inventor: Shuichi Mogi, Utsunomiya-shi (JP)

Correspondence Address: JACOBSON HOLMAN PLLC, 400 SEVENTH STREET N.W., SUITE 600, WASHINGTON, DC, 20004, US

(21) Appl. No.: 12/314,210

(22) Filed: Dec. 5, 2008

(30) Foreign Application Priority Data
Dec. 7, 2007 (JP) 2007-317172

(51) Int. Cl. G02B 15/20

(52) U.S. Cl. 359/684

(57) ABSTRACT

Rear focusing zoom lens capable of attaining the desired brightness as much as 1.8 in F-number with the zooming ratio of 11× or above, reducing distortion aberration for the photoshooting at the wide-angle end, compensating for axial chromatic aberration and chromatic aberration at the telephoto end, minimizing a diameter of the leading lens piece and the entire length of the lens optics, satisfying a requirement of the reduced weight

### FIELD OF THE INVENTION

The present invention relates to a longitudinally down-sized, enhanced aperture ratio and high variable power ratio, rear focusing zoom lens that is capable of attaining 11× or more of the zooming ratio to cover a wide-angle view range used for video cameras and the like and that is configured with five groups of lens pieces to perform the rear focusing.

### BACKGROUND ART

In the prior art, there have been provided zoom lenses suitable especially for video cameras and the photography that are of high variable power ratio as much as 10× and of aperture ratio as large as approximately 1.8 in F-number (see Patent Document 1 listed below). Some of such zoom lenses has multi groups of lens pieces where a leading or 1st lens group of positive refractivity, a 2nd lens group of negative refractivity, a 3rd lens group of positive refractivity, a 4th lens group of positive refractivity, and a 5th lens group of negative refractivity are arranged in this order from the foremost side closest to a photo-shot subject, and at least the 2nd and the 4th of the groups of lens pieces are to be moved to alter the power ratio and zoom in and out while the 2nd lens group is moved for the focusing.

Another embodiment of the prior art provides a zoom lens that is also of multi group of lens pieces where a leading or 1st lens group of positive refractivity that are fixed during the zooming, a 2nd lens group of negative refractivity that are movable during the zooming to zoom in and out, a 3rd lens group of positive refractivity that are fixed during the zooming, and a 4th lens group of positive refractivity that are movable during the zooming to mainly correct an imaging position (see Patent Document 2 listed below). This type of the zoom lenses is comprised of the 3rd lens group that includes four or less lens pieces in total, having a positive lens piece closest to the subject of which foremost surface is shaped in convex and one or more succeeding negative lens pieces, and the 4th lens group that includes simply a single positive lens piece or two of the positive lens pieces which has (have) at least one surface shaped in aspherical that is designed to have a refractive power diminished as it comes farther from the optical axis.

Still another embodiment of the prior art provides a rear focusing zoom lens of multi groups of lens pieces where a leading or 1st lens group of positive refractivity, a 2nd lens group of negative refractivity, a 3rd lens group of positive refractivity, a 4th lens group of positive refractivity, and a 5th lens group of negative refractivity arranged in this order on the closest to the photo-shot subject first basis (see Patent Document 3 listed below). This type of the rear focusing zoom lenses moves the 2nd and the 4th of the groups of lens pieces for the zooming. For the focusing, the 4th lens group are moved.

### Patent Document 1

### Japanese Patent No. 3513265

### Patent Document 2

Japanese Publication of Unexamined Patent Application No. H4-43311

### Patent Document 3

Japanese Publication of Unexamined Patent Application No. H4-301612

The aforementioned prior art zoom lenses, which have the 1st lens group of positive refractivity, the 2nd lens group of negative refractivity, the 3rd lens group of positive refractivity, and the 4th lens group of positive refractivity, or namely, the multi groups of lens pieces, all encounter difficulties in meeting a need to attain an increased aperture ratio associated with the recent accelerated tendency to develop more enhanced pixel based imaging technology and in satisfactorily compensating for various types of aberration during the zooming in and out between the wide-angle end and the telephoto end with the zooming ratio raised up to 10× or even higher, and especially, they all conspicuously fail to correct chromatic aberration at the telephoto end. An approach to compensate for the chromatic aberration also has failed, resulting in the leading lens piece or the front cell unavoidably increasing its diameter and disadvantageously causing the entire length of the zoom lens to become greater.

The present invention is made to overcome the above disadvantages in the prior art embodiments, and accordingly, it is an object of the present invention to provide an improved rear focusing zoom lens that is capable of attaining the desired brightness as much as 1.8 in F-number with the zooming ratio of 11× or above, e.g., as high as 12×, ensuring a large aperture ratio to reduce distortion aberration for the photoshooting at the wide-angle end, compensating for axial chromatic aberration and chromatic aberration at the telephoto end, minimizing a diameter of the leading lens piece and the entire length of the lens optics, relatively simplifying a lens structure to facilitate the manufacturing, thereby satisfying a requirement of the reduced weight.

### SUMMARY OF THE INVENTION

In one aspect of the invention, there is provided a rear focusing zoom lens that is comprised of multi groups of lens pieces, namely, a leading or 1st lens group of positive refractivity, a 2nd lens group of negative refractivity, a 3rd lens group of positive refractivity, a 4th lens group of positive refractivity, and a 5th lens group of negative refractivity in this order on the closest to a photo-shot subject first basis where the 2nd lens group are moved along the optical axis from their respective position closer to the subject to an imaging plane so as to alter a variable power from the wide-angle view to the telephoto view while the 4th lens group are moved along the optical axis for the focusing;

the zoom lens satisfying the requirements as follows:

0<(DW−Δe34)/(z·DW)<0.09 Requirement Formula 1

0.3<|f2|/f3<0.4 Requirement Formula 2

where Δe34 is a varied amount of an interval between principal points of the 3rd and 4th lens groups at the telephoto end relative to that at the wide-angle end; Z is a zooming ratio, DW is a length of the entire optics, namely, between the front surface of the foremost lens piece and the rear surface of the rearmost lens piece, at the wide-angle end; f2 is a focal length of the 2nd lens group; and f3 is the focal length of the 3rd lens group.

In another aspect of the present invention, there is provided a rear focusing zoom lens that is comprised of multi groups of lens pieces, namely, a 1st lens group of positive refractivity, a 2nd lens group of negative refractivity, a 3rd lens group of positive refractivity, a 4th lens group of positive refractivity, and a 5th lens group of negative refractivity in this order from the closest to a photo-shot subject first basis where the 2nd lens group are moved along the optical axis from the subject to an imaging plane so as to alter a variable power from the wide-angle view to the telephoto view while the 4th lens group are moved along the optical axis for the focusing;

the zoom lens satisfying the requirements as follows:

0<(DW−Δe34)/(z·DW)<0.09 Requirement Formula 1

0.3<fW/f45W<0.4 Requirement Formula 3

where Δe34 is a varied amount of an interval between principal points of the 3rd and 4th lens groups at the telephoto end relative to that at the wide-angle end; Z is a zooming ratio, DW is a length of the entire optics, namely, between the front surface of the foremost lens piece and the rear surface of the rearmost lens piece, at the wide-angle end; fW is a focal length of the entire optics at the wide-angle end; and f45W is a synthesized focal length of the 4th and 5th lens groups at the wide-angle end.

In still another aspect of the present invention, there is provided a rear focusing zoom lens that is comprised of multi groups of lens pieces, namely, a 1st lens group of positive refractivity, a 2nd lens group of negative refractivity, a 3rd lens group of positive refractivity, a 4th lens group of positive refractivity, and a 5th lens group of negative refractivity in this order on the closest to a photo-shot subject first basis where the 2nd lens group are moved along the optical axis from the subject to an imaging plane so as to alter a variable power from the wide-angle view to the telephoto view while the 4th lens group are moved along the optical axis for the focusing;

the zoom lens satisfying the requirements as follows:

0<(DW−Δe34)/(z·DW)<0.09 Requirement Formula 1

0.3<fW/f4<0.4 Requirement Formula 4

where Δe34 is a varied amount of an interval between principal points of the 3rd and 4th lens groups at the telephoto end relative to that at the wide-angle end; Z is a zooming ratio, DW is a length of the entire optics, namely, between the front surface of the foremost lens piece and the rear surface of the rearmost lens piece, at the wide-angle end; fW is a focal length of the entire optics at the wide-angle end; and f4 is a focal length of the 4th lens group.

The invention in the above-mentioned aspects is implemented in manners as follows:

The 2nd lens group have one or more lens pieces that have a surface closer to the subject shaped in concave and the concave surface is aspherical.

The 3rd lens group have one or more lens pieces that have a surface closer to the subject shaped in convex and the convex surface is aspherical.

The 4th lens group have one or more lens pieces that have a surface closer to the subject shaped in convex and the convex surface is aspherical.

While the 2nd lens group are moving along the optical axis, the 4th lens group are also moved along the optical axis so as to alter the variable power and fix the imaging plane in position.

In the rear focusing zoom lens according to the present invention, the desired brightness as expressed by F-number 1.8 is attained with the zooming ratio of 11× to 12×, and the increased aperture ratio effectively reduces distortion aberration when the zoom lens takes a posture of the wide-angle end.

Also, according to the present invention, the rear focusing zoom lens can reduce axial chromatic aberration and chromatic aberration at the telephoto end, and additionally, it can reduce a diameter of the foremost lens piece and the entire length of the zoom lens and has a structure that is relatively simplified to facilitate the manufacturing, thereby satisfying a requirement of the reduced weight.

The formula (1) of the present invention designates a requirement for attaining the enhanced magnification power and reducing the diameter of the foremost lens piece and the entire length of the zoom lens.

If the 3rd lens group has its refractivity reduced so much as to exceed the lower limit as designated in the formula (2) of the present invention, it is hard to compensate for spherical aberration and comatic aberration.

If the variable power is as high as the 4th and 5th lens groups have their respective magnification powers raised so much as to exceed the upper limit as designated in the formula (3), it is hard to compensate for astigmatism caused in the 1st and 2nd lens groups.

The formula (4) defines the magnification power of the 4th lens group, and if the 4th lens group has its refractivity reduced so much as to exceed the pre-defined lower limit, the 4th lens group are to be excessively moved, which disadvantageously necessitates an increase in the entire length of the zoom lens to ensure the required space for strokes of the 4th lens group.

### BRIEF DESCRIPTION OF THE DRAWINGS

FIG. 1 is a sectional view showing an embodiment of a rear focusing zoom lens according to the present invention when the zoom lens takes a posture of a wide-angle end (A), a middle focal length (B), and a telephoto end (C), respectively.

FIG. 2 is a graph illustrating a spherical aberration in the exemplary rear focusing zoom lens postured at the wide-angle end in accordance with the present invention.

FIG. 3 is a graph illustrating a chromatic aberration of variable in the exemplary rear focusing zoom lens at the wide-angle end in accordance with the present invention.

FIG. 4 is a graph illustrating an astigmatism in the exemplary rear focusing zoom lens at the wide-angle end in accordance with the present invention.

FIG. 5 is a graph illustrating a distortion aberration in the exemplary rear focusing zoom lens at the wide-angle end in accordance with the present invention.

FIG. 6 is a graph illustrating the spherical aberration in the exemplary rear focusing zoom lens postured at the middle focal length in accordance with the present invention.

FIG. 7 is a graph illustrating the chromatic aberration of variable in the exemplary rear focusing zoom lens at the middle focal length in accordance with the present invention.

FIG. 8 is a graph illustrating the astigmatism in the exemplary rear focusing zoom lens at the middle focal length in accordance with the present invention.

FIG. 9 is a graph illustrating the distortion aberration in the exemplary rear focusing zoom lens at the middle focal length in accordance with the present invention.

FIG. 10 is a graph illustrating the spherical aberration in the exemplary rear focusing zoom lens postured at the telephoto end in accordance with the present invention.

FIG. 11 is a graph illustrating the chromatic aberration of variable in the exemplary rear focusing zoom lens at the telephoto end in accordance with the present invention.

FIG. 12 is a graph illustrating the astigmatism in the exemplary rear focusing zoom lens at the telephoto end in accordance with the present invention.

FIG. 13 is a graph illustrating the distortion aberration in the exemplary rear focusing zoom lens at the telephoto end in accordance with the present invention.

FIG. 14 is a sectional view of another embodiment of the rear focusing zoom lens according to the present invention when the zoom lens takes a posture of a wide-angle end (A), a middle focal length (B), and a telephoto end (C), respectively.

FIG. 15 is a graph illustrating the spherical aberration in the exemplary rear focusing zoom lens postured at the wide-angle end in accordance with the present invention.

FIG. 16 is a graph illustrating the chromatic aberration of variable in the exemplary rear focusing zoom lens at the wide-angle end in accordance with the present invention.

FIG. 17 is a graph illustrating the astigmatism in the exemplary rear focusing zoom lens at the wide-angle end in accordance with the present invention.

FIG. 18 is a graph illustrating the distortion aberration in the exemplary rear focusing zoom lens at the wide-angle end in accordance with the present invention.

FIG. 19 is a graph illustrating the spherical aberration in the exemplary rear focusing zoom lens postured at the middle focal length in accordance with the present invention.

FIG. 20 is a graph illustrating the chromatic aberration of variable in the exemplary rear focusing zoom lens at the middle focal length in accordance with the present invention.

FIG. 21 is a graph illustrating the astigmatism in the exemplary rear focusing zoom lens at the middle focal length in accordance with the present invention.

FIG. 22 is a graph illustrating the distortion aberration in the exemplary rear focusing zoom lens at the middle focal length in accordance with the present invention.

FIG. 23 is a graph illustrating the spherical aberration in the exemplary rear focusing zoom lens postured at the telephoto end in accordance with the present invention.

FIG. 24 is a graph illustrating the chromatic aberration of variable in the exemplary rear focusing zoom lens at the telephoto end in accordance with the present invention.

FIG. 25 is a graph illustrating the astigmatism in the exemplary rear focusing zoom lens at the telephoto end in accordance with the present invention.

FIG. 26 is a graph illustrating the distortion aberration in the exemplary rear focusing zoom lens at the telephoto end in accordance with the present invention.

FIG. 27 is a sectional view of still another embodiment of the rear focusing zoom lens according to the present invention when the zoom lens takes a posture of a wide-angle end (A), a middle focal length (B), and a telephoto end (C), respectively.

FIG. 28 is a graph illustrating the spherical aberration in the exemplary rear focusing zoom lens postured at the wide-angle end in accordance with the present invention.

FIG. 29 is a graph illustrating the chromatic aberration of variable in the exemplary rear focusing zoom lens at the wide-angle end in accordance with the present invention.

FIG. 30 is a graph illustrating the astigmatism in the exemplary rear focusing zoom lens at the wide-angle end in accordance with the present invention.

FIG. 31 is a graph illustrating the distortion aberration in the exemplary rear focusing zoom lens at the wide-angle end in accordance with the present invention.

FIG. 32 is a graph illustrating the spherical aberration in the exemplary rear focusing zoom lens postured at the middle focal length in accordance with the present invention.

FIG. 33 is a graph illustrating the chromatic aberration of variable in the exemplary rear focusing zoom lens at the middle focal length in accordance with the present invention.

FIG. 34 is a graph illustrating the astigmatism in the exemplary rear focusing zoom lens at the middle focal length in accordance with the present invention.

FIG. 35 is a graph illustrating the distortion aberration in the exemplary rear focusing zoom lens at the middle focal length in accordance with the present invention.

FIG. 36 is a graph illustrating the spherical aberration in the exemplary rear focusing zoom lens postured at the telephoto end in accordance with the present invention.

FIG. 37 is a graph illustrating the chromatic aberration of variable in the exemplary rear focusing zoom lens at the telephoto end in accordance with the present invention.

FIG. 38 is a graph illustrating the astigmatism in the exemplary rear focusing zoom lens at the telephoto end in accordance with the present invention.

FIG. 39 is a graph illustrating the distortion aberration in the exemplary rear focusing zoom lens at the telephoto end in accordance with the present invention.

### DETAILED DESCRIPTION OF THE PREFERRED EMBODIMENTS

### Embodiment 1

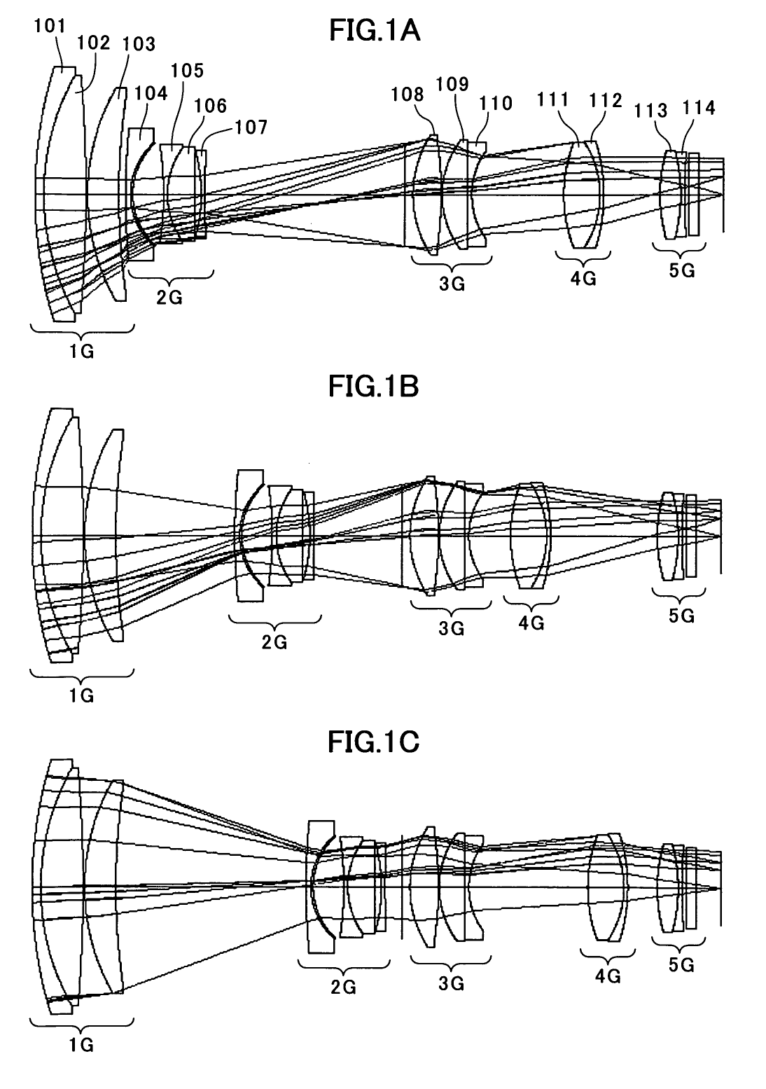

An embodiment of a rear focusing zoom lens according to the present invention has, as shown in FIG. 1, multi groups of lens pieces, namely, a 1st lens group 1G, a 2nd lens group 2G, a 3rd lens group 3G, a 4th lens group 4G, and a 5th lens group 5G.

The 1st lens group 1G includes a negative lens piece 101, a positive lens piece 102, and a positive lens piece 103 arranged in this order on the closest to a photo-shot subject first basis. The 2nd lens group 2G includes a negative lens piece 104, a negative lens piece 105, a positive lens piece 106, and a negative lens piece 107 arranged in this order on the closest to the subject first basis. The 3rd lens group 3G includes a positive lens piece 108, a positive lens piece 109, and a negative lens piece 110 arranged in this order on the closest to the subject first basis. The 4th lens group 4G includes a positive lens piece 111 closer to the subject and a negative lens piece 112 trailing after. The 5th lens group 5G includes a positive lens piece 113 closer to the subject and a negative lens piece 114 trailing after.

The lens groups are moved along on the optical axis to alter a variable power in stepwise postures of a wide-angle end as depicted in FIG. 1(A), a middle focal length as in FIG. 1(B), and a telephoto end as in FIG. 1(C), respectively. Specifically, the 2nd lens group 2G are moved from a position closer to the photo-shot subject to the imaging plane so as to alter the variable power from the wide-angle end to the middle focal length, and further to the telephoto end. At the same time, in order to fix the imaging plane in position in accord with altering the variable power from the wide-angle end through the middle focal length to the telephoto end, the 4th lens group 4G are first moved from the initial position closer to the imaging plane toward the subject, and then moved back to the imaging plane, namely, the 4th lens group 4G take a shuttling trajectory for the three-stepwise succeeding photo-shooting.

Particular data on each lens group are shown in Table 1 below. In Table 1, No. denotes a surface number, R is a radius of curvature (in millimeters), D represents an interval between adjacent ones of the surfaces (in millimeters), Nd is a refractivity (with a wavelength of 587.6 nm), and vd is an Abbe number (with the wavelength of 587.6 nm). Also, in Table 1, the 5th surface, the 13th surface, the 20th surface, and the 23rd surface are spaced from their respective succeeding surfaces by a distance that designates an interval required for the variable power of the wide-angle end, the medical focal length, or the telephoto end.

The 8th, the 16th, the 17th and the 21st of the surfaces are all aspherical. A mathematical definition of the aspherical surfaces is given by the following formula (1) where X is an aspherical shape, R is a radius of curvature, ε is a conic coefficient, and H is a height from the optical axis (in millimeters). Constants of the aspherical surfaces, A, B, C, D and E, are defined in Table 2 below.

$$X = \frac{{H}^{2} / R}{1 + \sqrt{1 - ɛ {H}^{2} / {R}^{2}}} + {AH}^{2} + {BH}^{4} + {CH}^{6} + {DH}^{8} + {EH}^{10} \qquad ( 1 )$$

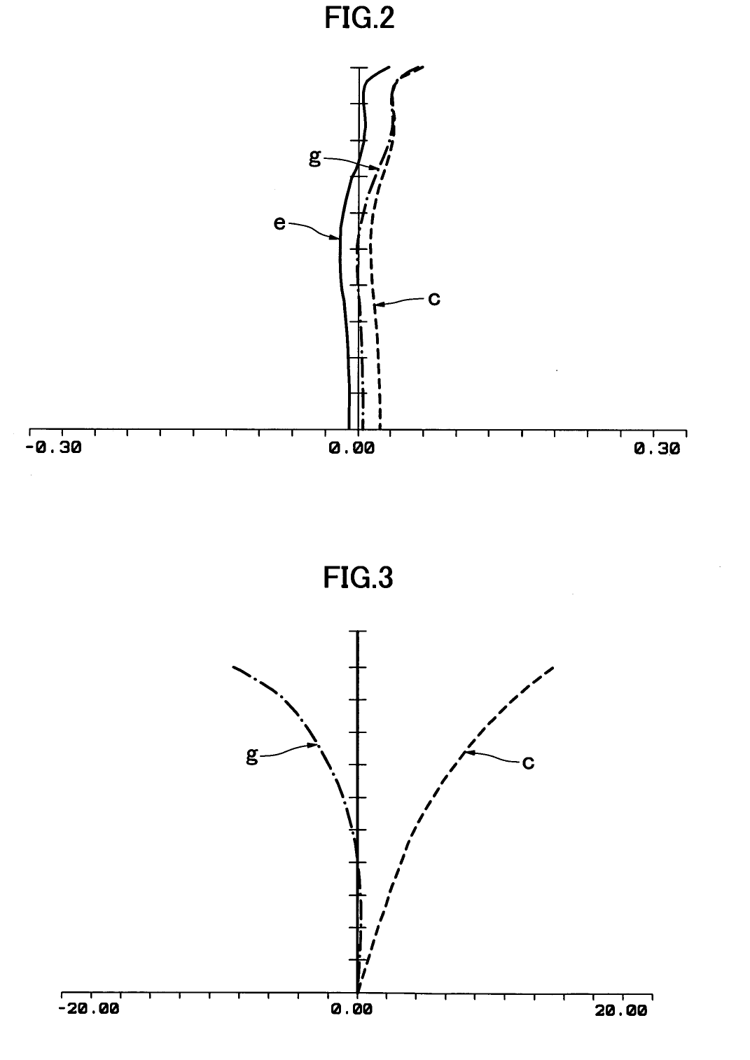

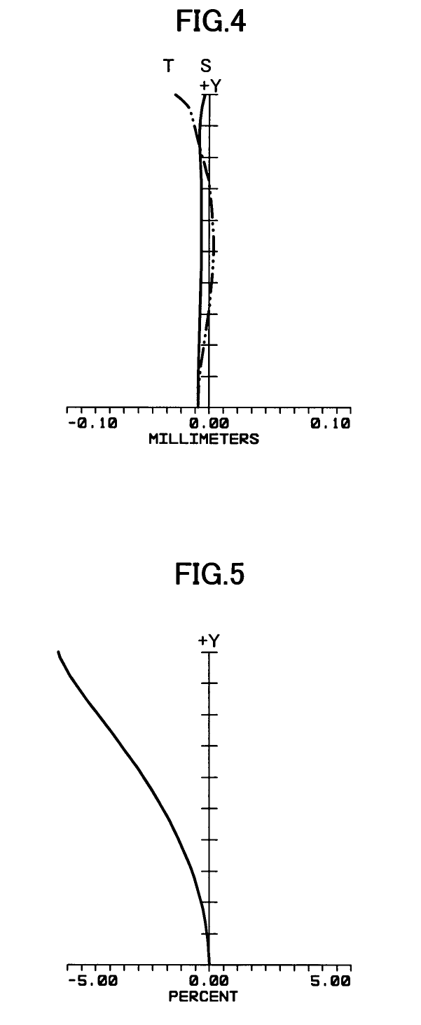

Various types of aberration prone to be caused in this embodiment are depicted in FIG. 2 to FIG. 13. In these graphs, numerical representations are given in millimeters (mm); and g denotes a g-line aberration while c does a c-line aberration. FIG. 2 provides a graph on a spherical aberration with the zoom lens being settled at the wide-angle end, assuming that an aperture stop is 1.6665 mm in radius. FIG. 3 is a graph illustrating a chromatic aberration of magnification, assuming that the light beam is incident at 3.7150 mm in height upon the zoom lens at the wide-angle end. FIG. 4 provides a graph on an astigmatism at the wide-angle end. FIG. 5 is a graph illustrating a distortion aberration at the wide-angle end.

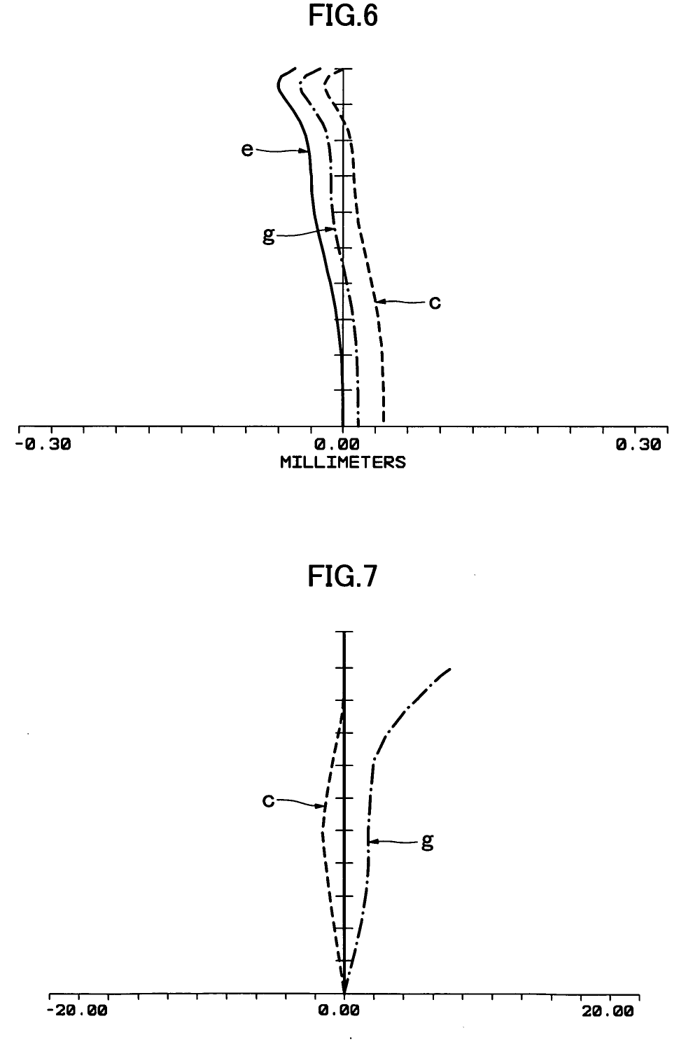

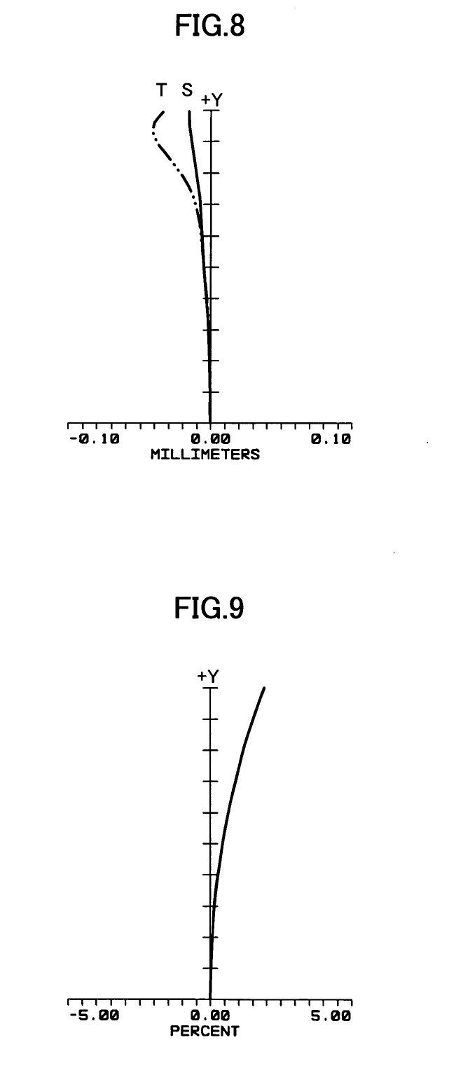

FIG. 6 provides a graph on the spherical aberration with the zoom lens being settled at the medium focal length in the course of the zooming, assuming that the aperture stop is 5.2254 mm in radius. FIG. 7 is a graph illustrating the chromatic aberration of magnification, assuming that the incident beam is 3.7150 mm in height upon the zoom lens at the medium focal length. FIG. 8 is a graph on the astigmatism at the medium focal length. FIG. 9 is a graph illustrating the distortion aberration at the medium focal length.

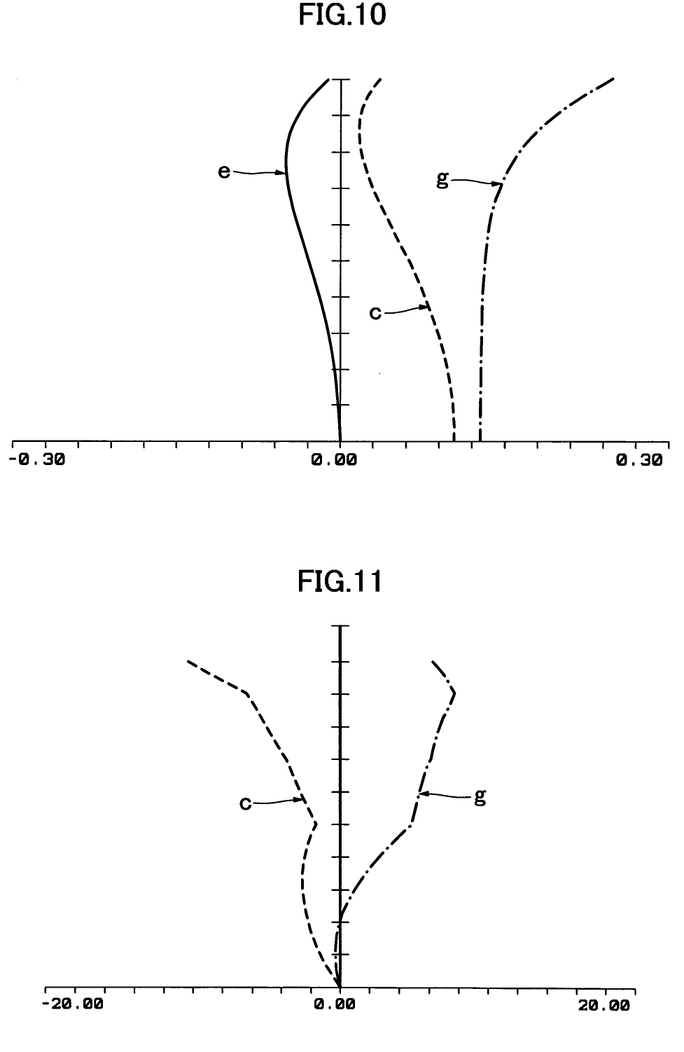

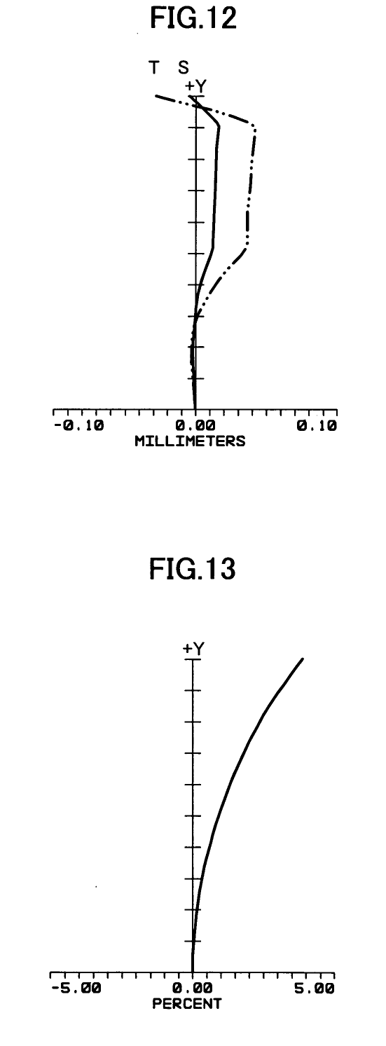

FIG. 10 provides a graph on the spherical aberration with the zoom lens reaching the telephoto end for the zooming, assuming that the aperture stop is 18.4197 mm in radius. FIG. 11 is a graph illustrating the chromatic aberration of magnification, assuming that the incident beam is 3.7150 mm in height upon the zoom lens at the telephoto end. FIG. 12 is a graph on the astigmatism at the telephoto end. FIG. 13 is a graph illustrating the distortion aberration at the telephoto end.

Values for arithmetic operations in this embodiment are given as follows:

| | |
|---|---|
| fW (focal length at the wide-angle end) | 6.27 |
| ft (focal length at the telephoto end) | 71.46 |
| z (zoom ratio) | 11.40 |
| DW (length from the foremost surface of the 1st lens piece | 68.9934 |
| to the rearmost surface of the trailing lens piece) | |
| DT (length from the foremost surface of the 1st lens piece | 68.9934 |
| to the rearmost surface of the trailing lens piece) | |
| f1 (focal length of the 1st lens group) | 31.7188 |
| f2 (focal length of the 2nd lens group) | −6.3462 |
| f3 (focal length of the 3rd lens group) | 19.0965 |
| f4 (focal length of the 4th lens group) | 17.5504 |
| f5 (focal length of the 5th Lens group) | −202.162 |
| Δe34 | 2.95 |
| (varied amount of an interval between the primary points of | |
| the 3rd and 4th lens groups at the telephoto end relative to | |
| the wide-angle end) | |
| f45W (synthesized focal length of the 4th and 5th lens groups | 17.531 |
| at the wide-angle end) | |
| EPH (W) (radius of the aperture stop at the wide-angle end) | 1.6665 |
| EPH (T) (radius of the aperture stop at the telephoto end) | 18.4197 |
| FNO (W) (F-number at the wide-angle end) | 1.88 |
| FNO (T) (F-number at the telephoto end) | 1.94 |

Numerical values in terms of the requirement formulae are given as follows:

| | |
|---|---|
| 0 < (DT − Δe34)/(Z · DW) < 0.09 (Requirement Formula 1) | 0.084 |
| 0.3 < \|f2\|/f3 < 0.4 (Requirement Formula 2) | 0.332 |
| 0.3 < fW/f45W < 0.4 (Requirement Formula 3) | 0.358 |
| 0.3 < fW/f4 < 0.4 (Requirement Formula 4) | 0.357 |

### Embodiment 2

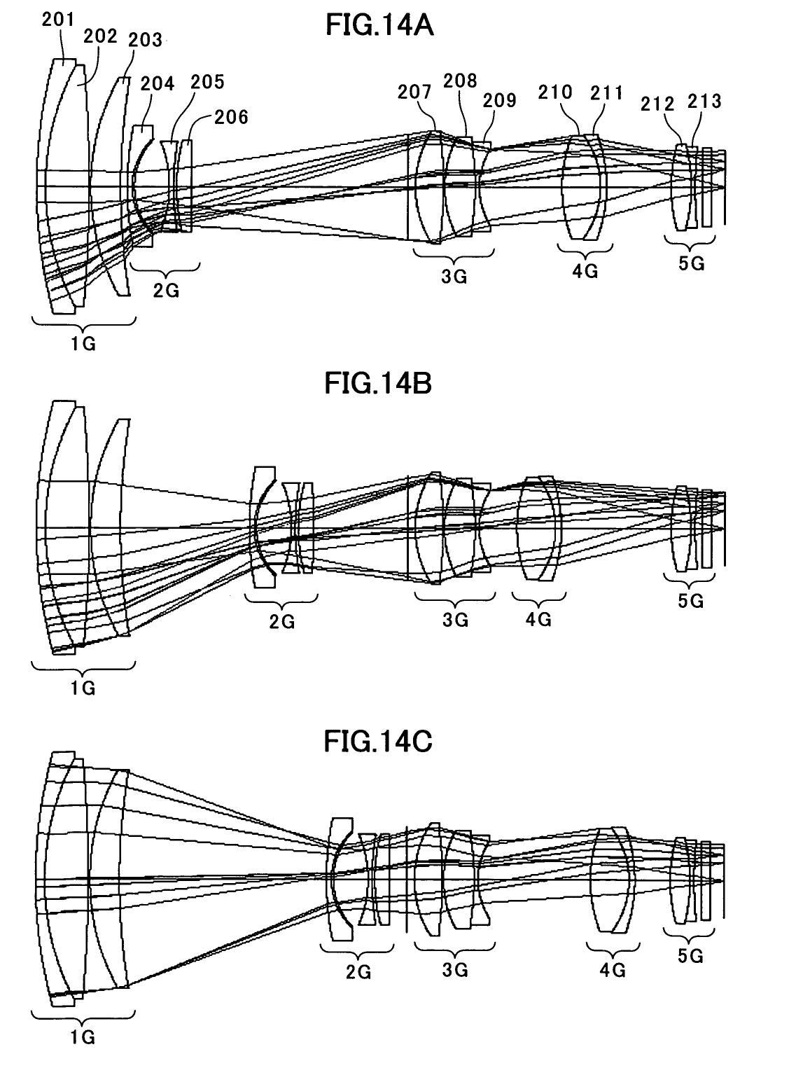

Another embodiment of the rear focusing zoom lens according to the present invention has, as can be seen in FIG. 14, a 1st lens group 1G, a 2nd lens group 2G, a 3rd lens group 3G, a 4th lens group 4G, and a 5th lens group 5G.

The 1st lens group 1G includes a negative lens piece 201, a positive lens piece 202, and a positive lens piece 203 arranged in this order on the closest to a photo-shot subject first basis. The 2nd lens group 2G includes a negative lens piece 204, a negative lens piece 205, and a positive lens piece 206 arranged in this order on the closest to the subject first basis. The 3rd lens group 3G includes a positive lens piece 207, a positive lens piece 208, and a negative lens piece 209 arranged in this order on the closest to the subject first basis. The 4th lens group 4G includes a positive lens piece 210 closer to the subject and a negative lens piece 211 trailing after. The 5th lens group 5G includes a positive lens piece 212 closer to the subject and a negative lens piece 213 trailing after.

The lens groups are moved along on the optical axis to alter a magnification power in stepwise postures of a wide-angle end as depicted in FIG. 14(A), a middle focal length as in FIG. 14(B), and a telephoto end as in FIG. 14(C), respectively. Specifically, the 2nd lens group 2G are moved from a position closer to the photo-shot subject to the imaging plane so as to alter the variable power from the wide-angle end to the middle focal length, and further to the telephoto end. At the same time, in order to fix the imaging plane in position in accord with altering the variable power from the wide-angle end through the middle focal length to the telephoto end, the 4th lens group 4G are first moved from the initial position closer to the imaging plane toward the subject, and then moved back to the imaging plane, namely, the 4th lens group 4G take a shuttling trajectory for the three-stepwise succeeding photo-shooting.

Particular data on each lens group are shown in Table 3 below, similar to Table 1. In Table 3, the 5th surface, the 12th surface, the 19th surface, and the 22nd surface are spaced from their respective succeeding surfaces by a distance that designates an interval required for the variable power of one of the wide-angle end, the medical focal length, and the telephoto end.

The 9th, the 16th, the 17th and the 21st of the surfaces are all aspherical. A mathematical definition of the aspherical surfaces is given by the formula (1) given above where X is an aspherical shape, R is a radius of curvature, ε is a conic coefficient, and H is a height from the optical axis (in millimeters). Constants of the aspherical surfaces, A, B, C, D and E, are defined in Table 4 below.

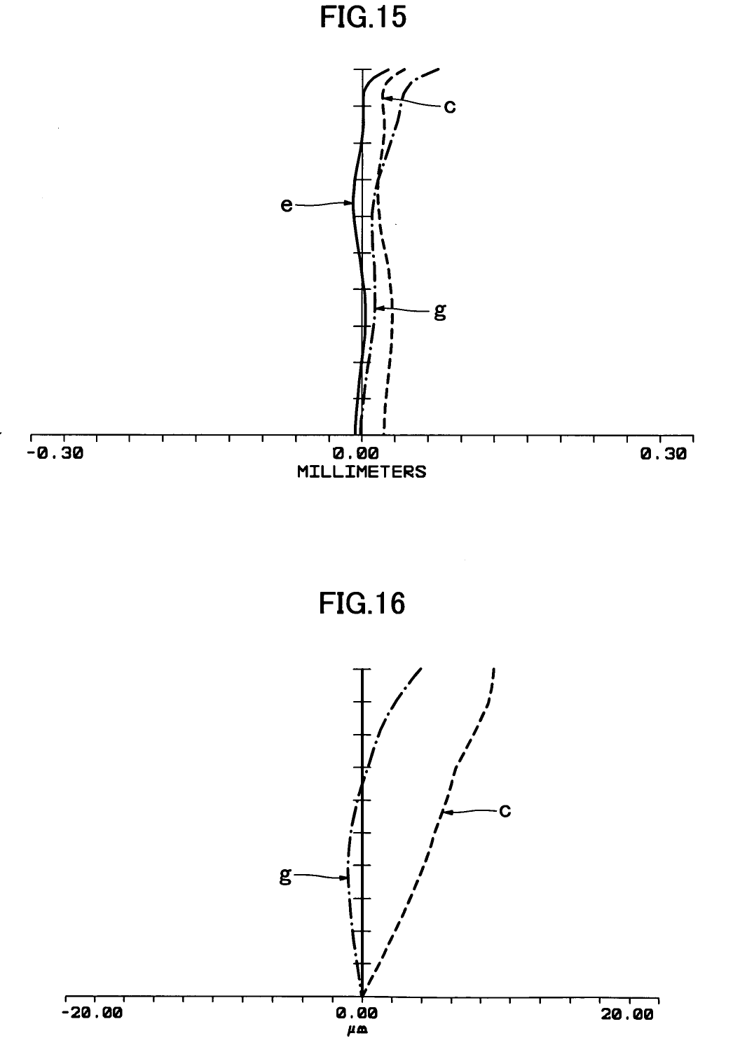

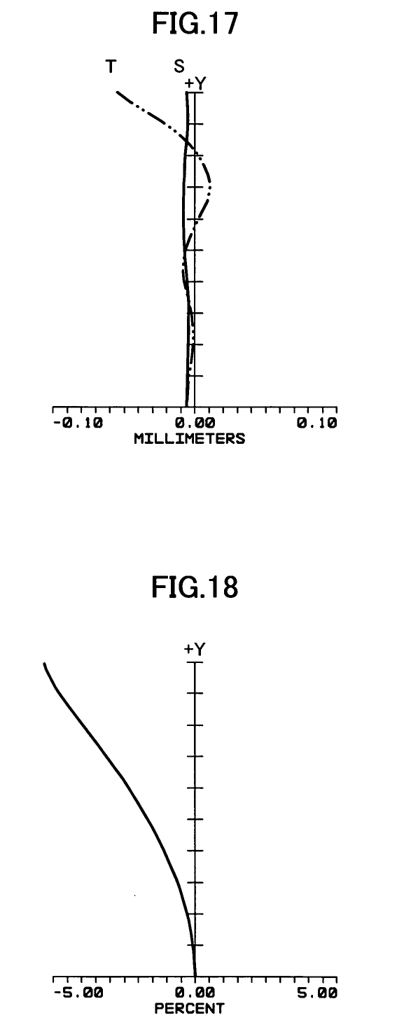

Various types of aberration prone to be caused in this embodiment are depicted in FIG. 15 to FIG. 26. In these graphs, numerical representations are given in millimeters (mm); and e denotes an e-line aberration, g denotes a g-line aberration, and c does a c-line aberration. FIG. 15 provides a graph on a spherical aberration with the zoom lens being settled at the wide-angle end, assuming that an aperture stop is 1.6581 mm in radius. FIG. 16 is a graph illustrating a chromatic aberration of magnification, assuming that the light beam is incident at 3.7150 mm in height upon the zoom lens at the wide-angle end. FIG. 17 provides a graph on an astigmatism at the wide-angle end. FIG. 18 is a graph illustrating a distortion aberration at the wide-angle end.

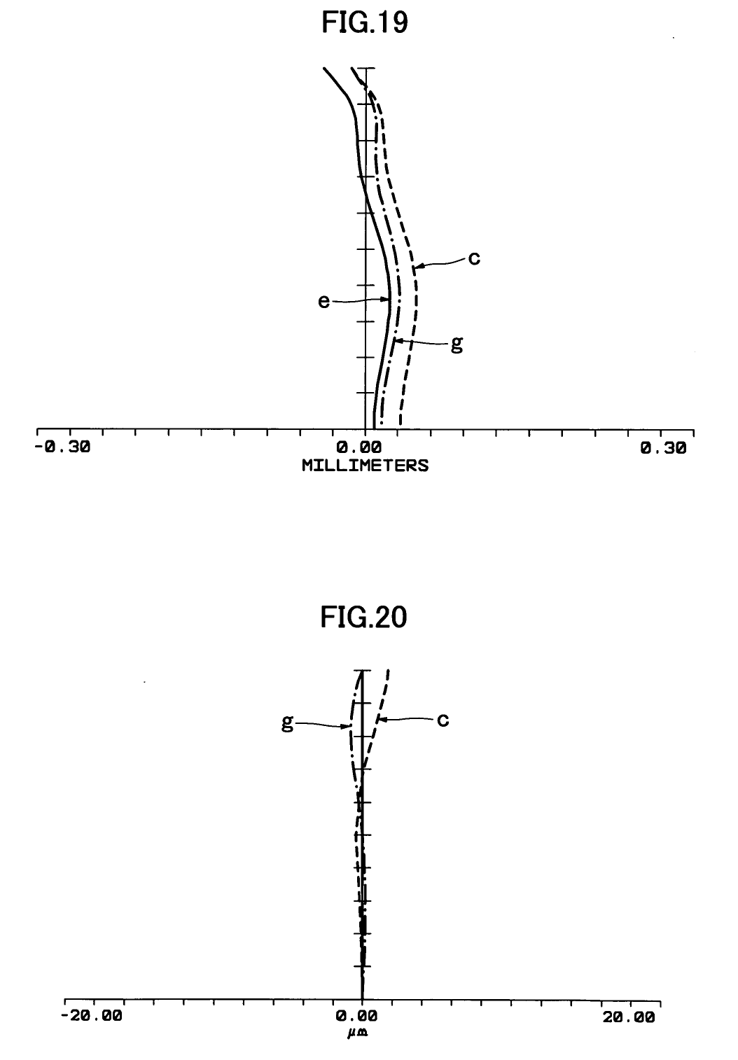

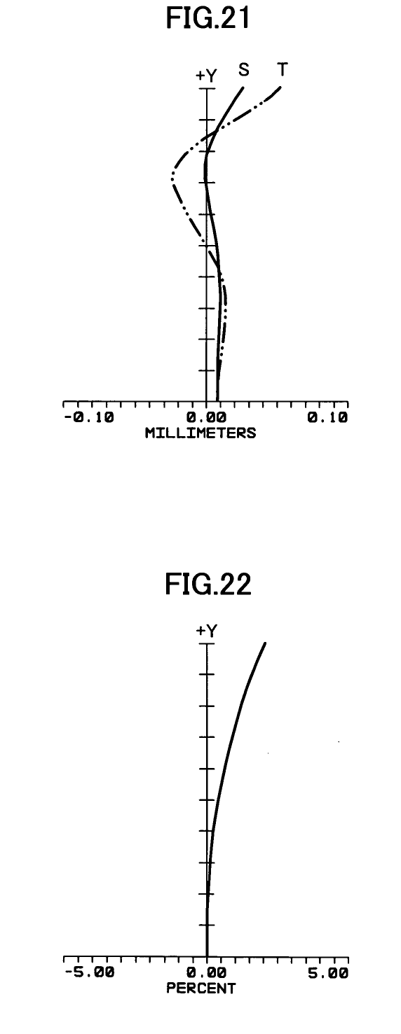

FIG. 19 provides a graph on the spherical aberration with the zoom lens being settled at the medium focal length in the course of the zooming, assuming that the aperture stop is 5.2007 mm in radius. FIG. 20 is a graph illustrating the chromatic aberration of magnification, assuming that the incident beam is 3.7150 mm in height upon the zoom lens at the medium focal length. FIG. 21 is a graph on the astigmatism at the medium focal length. FIG. 22 is a graph illustrating the distortion aberration at the medium focal length.

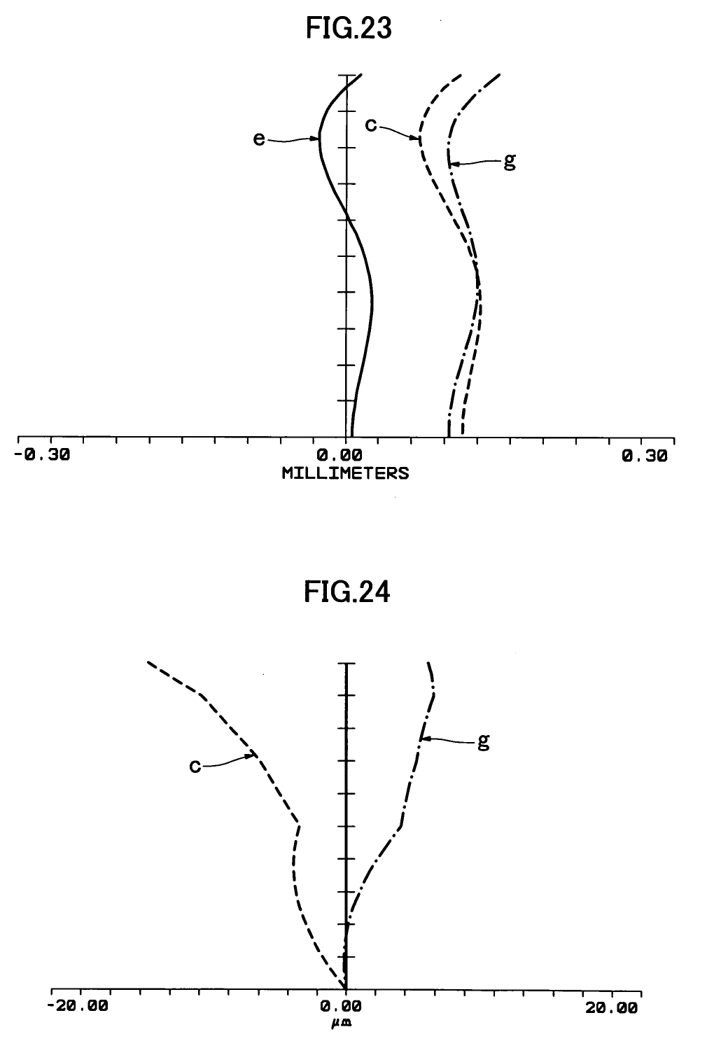

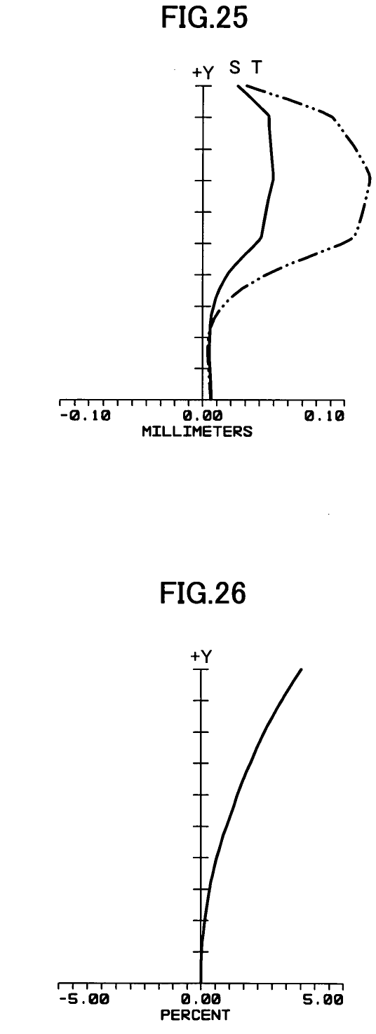

FIG. 23 provides a graph on the spherical aberration with the zoom lens being settled at the telephoto end for the zooming, assuming that the aperture stop is 18.2303 mm in radius. FIG. 24 is a graph illustrating the chromatic aberration of magnification, assuming the incident beam is 3.7150 mm in height upon the zoom lens at the telephoto end. FIG. 25 is a graph on the astigmatism at the telephoto end. FIG. 26 is a graph illustrating the distortion aberration at the telephoto end.

Values for arithmetic operations in this embodiment are given as follows:

| | |
|---|---|
| fW (focal length at the wide-angle end) | 6.27 |
| ft (focal length at the telephoto end) | 71.4352 |
| z (zoom ratio) | 11.39 |
| DW (length from the foremost surface of the 1st lens piece | 68.9833 |
| to the rearmost surface of the trailing lens piece) | |
| DT (length from the foremost surface of the 1st lens piece | 68.9833 |
| to the rearmost surface of the trailing lens piece) | |
| f1 (focal length of the 1st lens group) | 33.3396 |
| f2 (focal length of the 2nd lens group) | −7.0088 |
| f3 (focal length of the 3rd lens group) | 20.5296 |
| f4 (focal length of the 4th lens group) | 16.3903 |
| f5 (focal length of the 5th lens group) | −66.885 |
| Δe34 | 3.5517 |
| (varied amount of an interval between the primary points of | |
| the 3rd and 4th lens groups at the telephoto end relative to | |
| the wide-angle end) | |
| f45W (synthesized focal length of the 4th and 5th lens groups | 17.3122 |
| at the wide-angle end) | |
| EPH (W) (radius of the aperture stop at the wide-angle end) | 1.6581 |
| EPH (T) (radius of the aperture stop at the telephoto end) | 18.2303 |
| FNO (W) (F-number at the wide-angle end) | 1.89 |
| FNO (T) (F-number at the telephoto end) | 1.96 |

Numerical values in terms of the requirement formulae are given as follows:

| | |
|---|---|
| 0 < (DT − Δe34)/(Z · DW) < 0.09 (Requirement Formula 1) | 0.083 |
| 0.3 < \|f2\|/f3 < 0.4 (Requirement Formula 2) | 0.341 |
| 0.3 < fW/f45W < 0.4 (Requirement Formula 3) | 0.362 |
| 0.3 < fW/f4 < 0.4 (Requirement Formula 4) | 0.383 |

### Embodiment 3

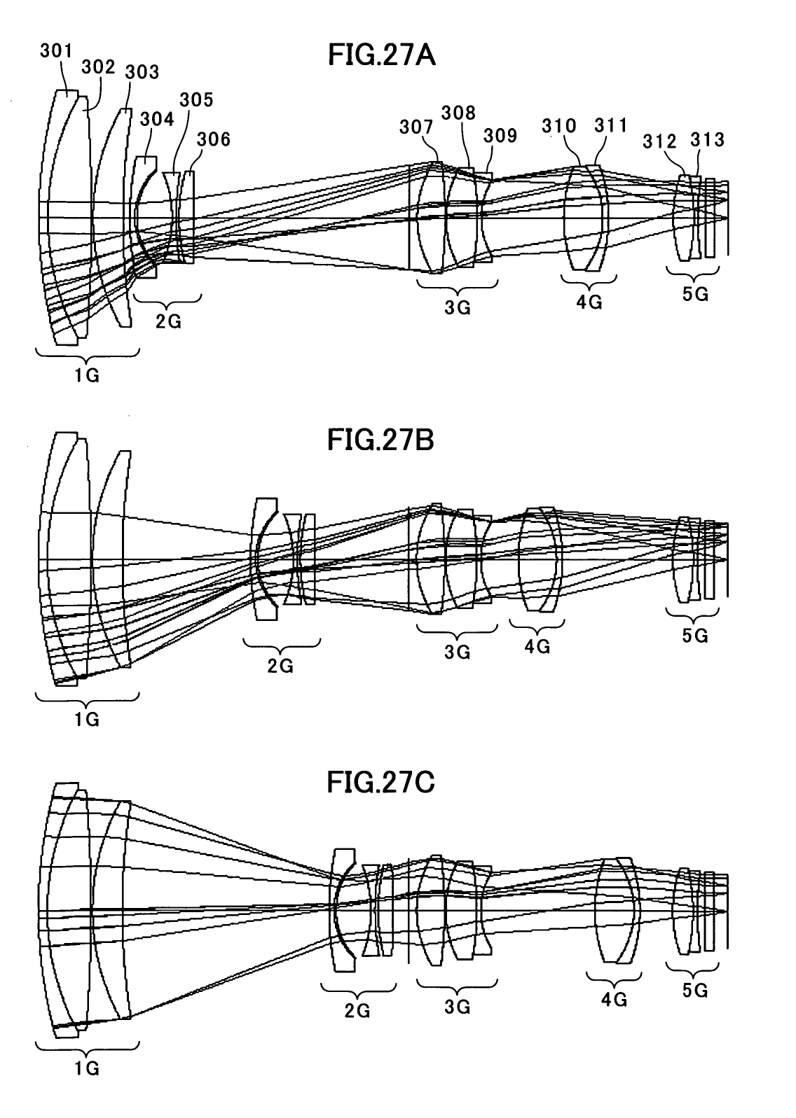

Still another embodiment of the rear focusing zoom lens according to the present invention has, as can be seen in FIG. 27, a 1st lens group 1G, a 2nd lens group 2G, a 3rd lens group 3G, a 4th lens group 4G, and a 5th lens group 5G.

The 1st lens group 1G includes a negative lens piece 301, a positive lens piece 302, and a positive lens piece 303 arranged in this order on the closest to a photo-shot subject first basis. The 2nd lens group 2G includes a negative lens piece 304, a negative lens piece 305, and a positive lens piece 306 arranged in this order on the closest to the subject first basis. The 3rd lens group 3G includes a positive lens piece 307, a positive lens piece 308, and a negative lens piece 309 arranged in this order on the closest to the subject first basis. The 4th lens group 4G includes a positive lens piece 310 closer to the subject and a negative lens piece 311 trailing after. The 5th lens group 5G includes a positive lens piece 312 closer to the subject and a negative lens piece 313 trailing after.

The lens groups are moved along on the optical axis to alter a variable power in stepwise positions of a wide-angle end as depicted in FIG. 27(A), a middle focal length as in FIG. 27(B), and a telephoto end as in FIG. 27(C), respectively. Specifically, the 2nd lens group 2G are moved from a position closer to the photo-shot subject to the imaging plane so as to alter the variable power from the wide-angle end to the middle focal length, and further to the telephoto end. At the same time, in order to fix the imaging plane in position in accord with altering the variable power from the wide-angle end through the middle focal length to the telephoto end, the 4th lens group 4G are first moved from the initial position closer to the imaging plane toward the subject, and then moved back to the imaging plane, namely, the 4th lens group 4G take a shuttling trajectory for the three-stepwise succeeding photo-shooting.

Particular data on each lens group are shown in Table 5 below, similar to Table 1. In Table 5, the 5th surface, the 12th surface, the 19th surface, and the 22nd surface are spaced from their respective succeeding surfaces by a distance that designates an interval required for the variable power of one of the wide-angle end, the medical focal length, and the telephoto end.

The 8th, the 15th, the 16th and the 21st of the surfaces are all aspherical. A mathematical definition of the aspherical surfaces is given by the formula (1) given above where X is an aspherical shape, R is a radius of curvature, ε is a conic coefficient, and H is a height from the optical axis (in millimeters).

Constants of the aspherical surfaces, A, B, C, D and E, are defined in Table 6 below.

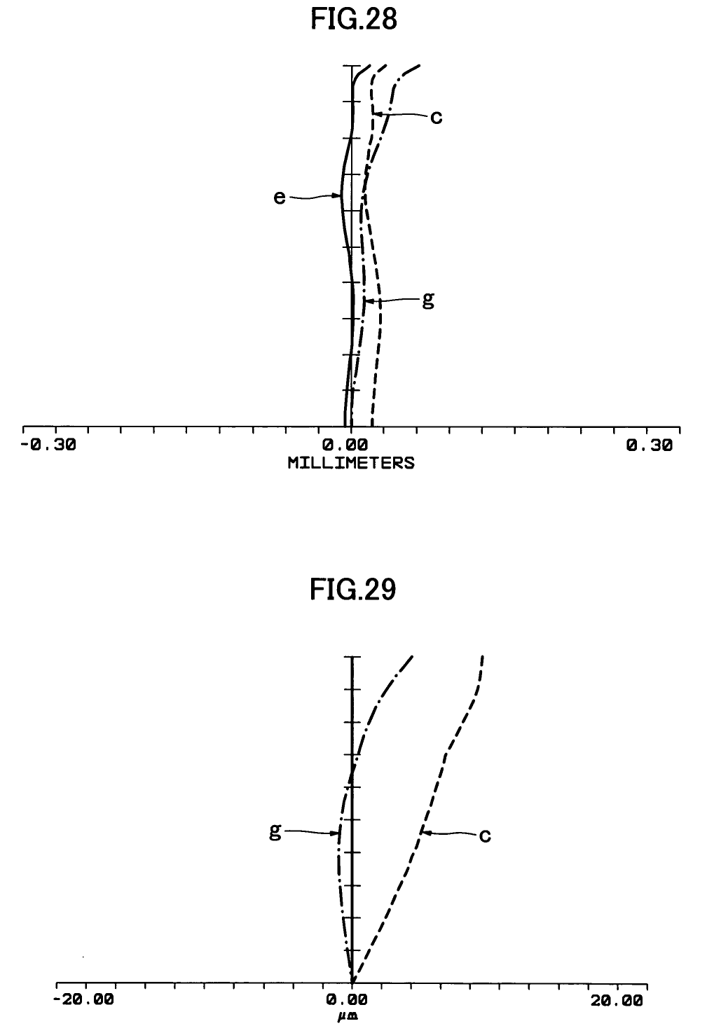

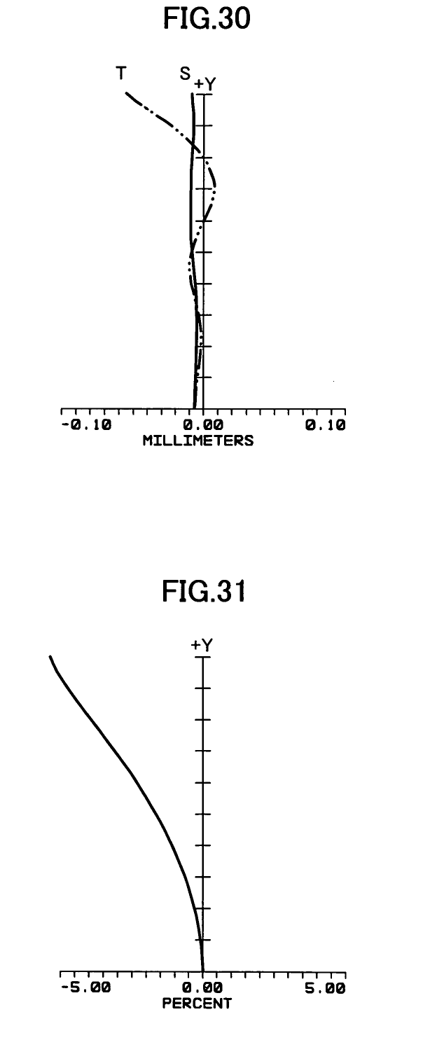

Various types of aberration prone to be caused in this embodiment are depicted in FIG. 28 to FIG. 39. In these graphs, numerical representations are given in millimeters (mm); and e denotes an e-line aberration, g denotes a g-line aberration, and c does a c-line aberration. FIG. 28 provides a graph on a spherical aberration with the zoom lens being settled at the wide-angle end, assuming that an aperture stop is 1.6588 mm in radius. FIG. 29 is a graph illustrating a chromatic aberration of magnification, assuming that the light beam is incident at 3.7150 mm in height upon the zoom lens at the wide-angle end. FIG. 30 provides a graph on an astigmatism at the wide-angle end. FIG. 31 is a graph illustrating a distortion aberration at the wide-angle end.

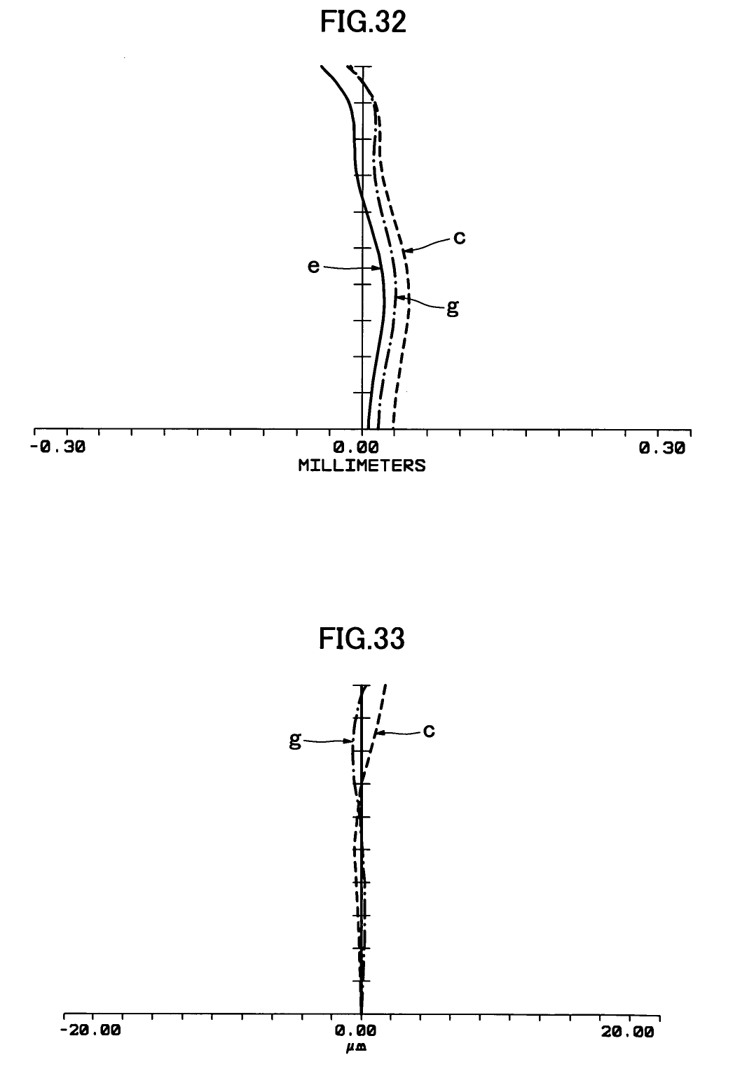

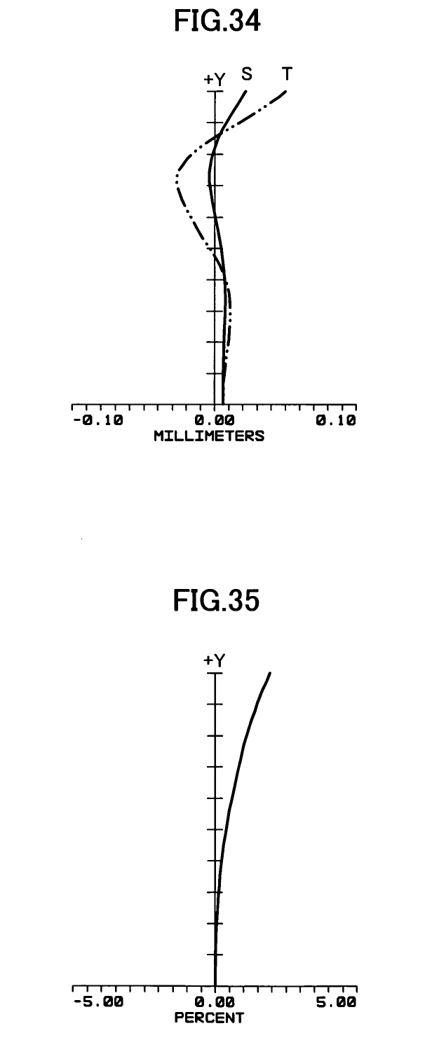

FIG. 32 provides a graph on the spherical aberration with the zoom lens being settled at the medium focal length in the course of the zooming, assuming that the aperture stop is 5.1886 mm in radius. FIG. 33 is a graph illustrating the chromatic aberration of magnification, assuming that the incident beam is 3.7150 mm in height upon the zoom lens at the medium focal length. FIG. 34 is a graph on the astigmatism at the medium focal length. FIG. 35 is a graph illustrating the distortion aberration at the medium focal length.

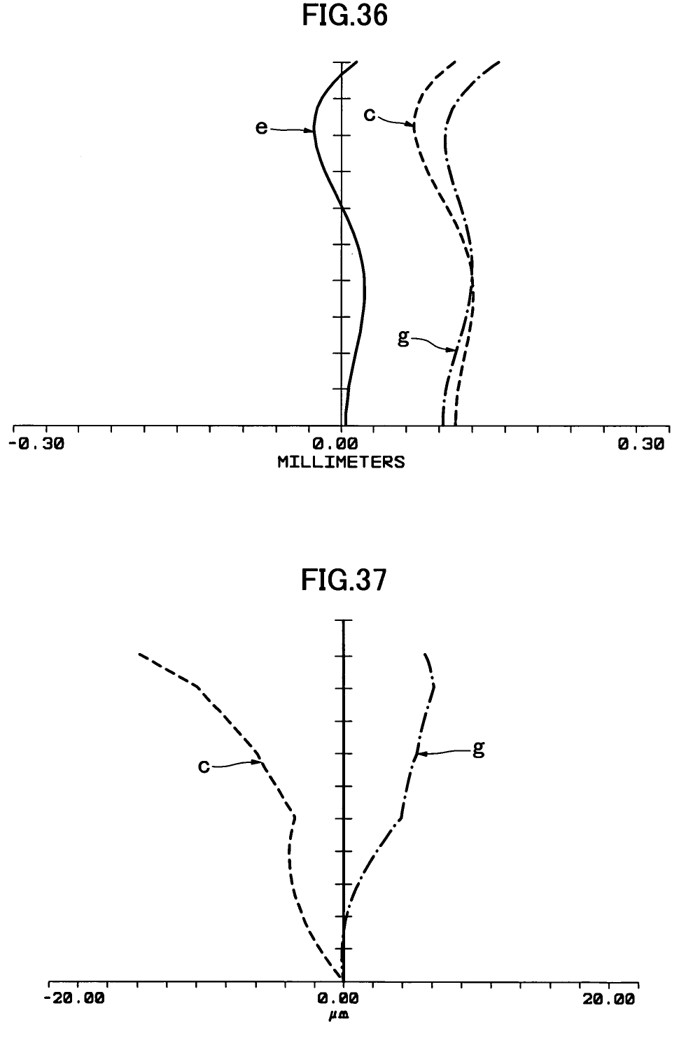

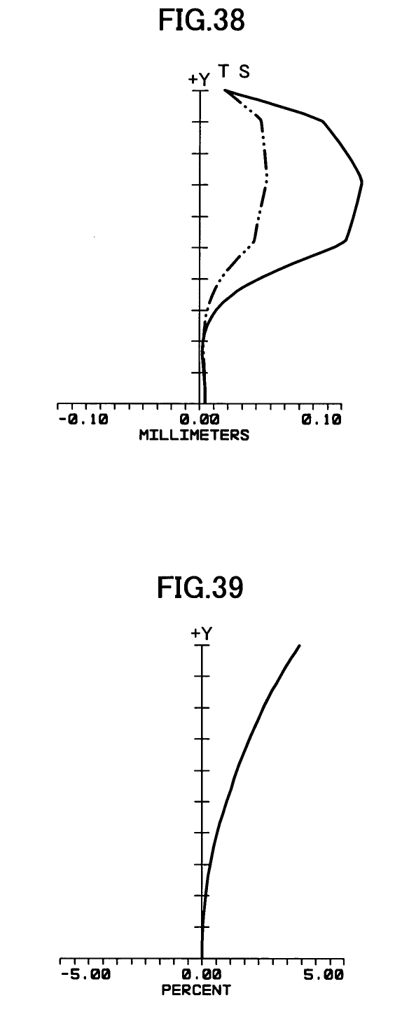

FIG. 36 provides a graph on the spherical aberration with the zoom lens being settled at the telephoto end for the zooming, assuming that the aperture stop is 18.1966 mm in radius. FIG. 37 is a graph illustrating the chromatic aberration of magnification, assuming the incident beam is 3.7150 mm in height upon the zoom lens at the telephoto end. FIG. 38 is a graph on the astigmatism at the telephoto end. FIG. 39 is a graph illustrating the distortion aberration at the telephoto end.

Values for arithmetic operations in this embodiment are given as follows:

| | |
|---|---|
| fW (focal length at the wide-angle end) | 6.27 |
| ft (focal length at the telephoto end) | 71.48 |
| z (zoom ratio) | 11.40 |
| DW (length from the foremost surface of the 1st lens piece | 68.9927 |
| to the rearmost surface of the trailing lens piece) | |
| DT (length from the foremost surface of the 1st lens piece | 68.9927 |
| to the rearmost surface of the trailing lens piece) | |
| f1 (focal length of the 1st lens group) | 33.2576 |
| f2 (focal length of the 2nd lens group) | −7.011 |
| f3 (focal length of the 3rd lens group) | 20.6755 |
| f4 (focal length of the 4th lens group) | 16.398 |
| f5 (focal length of the 5th lens group) | −69.679 |
| Δe34 | 3.3312 |
| (varied amount of an interval between the primary points of | |
| the 3rd and 4th lens groups at the telephoto end relative to | |
| the wide-angle end) | |
| f45W (synthesized focal length of the 4th and 5th lens groups | 17.0811 |
| at the wide-angle end) | |
| EPH (W) (radius of the aperture stop at the wide-angle end) | 1.6588 |
| EPH (T) (radius of the aperture stop at the telephoto end) | 18.1966 |
| FNO (W) (F-number at the wide-angle end) | 1.89 |
| FNO (T) (F-number at the telephoto end) | 1.96 |

Numerical values in terms of the requirement formulae are given as follows:

| | |
|---|---|
| 0 < (DT − Δe34)/(Z · DW) < 0.09 (Requirement Formula 1) | 0.083 |
| 0.3 < \|f2\|/f3 < 0.4 (Requirement Formula 2) | 0.339 |
| 0.3 < fW/f45W < 0.4 (Requirement Formula 3) | 0.367 |
| 0.3 < fW/f4 < 0.4 (Requirement Formula 4) | 0.382 |

TABLE 1

| No. | R | D | Nd | νd |
|---|---|---|---|---|
| 1 | 44.6551 | 0.90 | 1.8467 | 23.78 |
| 2 | 25.2301 | 4.26 | 1.4970 | 81.61 |
| 3 | −138.3913 | 0.15 | | |
| 4 | 22.1332 | 3.13 | 1.7348 | 54.70 |
| 5 | 70.2820 | 0.68-11.8836-19.0701 | | |
| 6 | 70.0917 | 0.50 | 1.8830 | 40.80 |
| 7 | 7.1345 | 0.20 | 1.5361 | 41.20 |
| 8 | 7.2010 | 3.07 | | |
| 9 | −34.1121 | 0.40 | 1.5395 | 51.20 |
| 10 | 8.2445 | 2.72 | 1.9479 | 21.70 |
| 11 | −6641.0249 | 0.65 | | |
| 12 | −16.8781 | 0.40 | 1.9037 | 31.32 |
| 13 | 127.0913 | 19.0901-7.8865-0.7 | | |
| 14 | INF | 1.00 | | |
| 15 | INF | 0.80 | | |
| 16 | 11.0879 | 2.83 | 1.6935 | 53.20 |
| 17 | −34.5813 | 0.08 | | |
| 18 | 9.3498 | 2.53 | 1.4970 | 81.61 |
| 19 | −388.9436 | 0.42 | 1.8946 | 32.10 |
| 20 | 7.6072 | 9.2396-4.1949-11.8789 | | |
| 21 | 15.1769 | 3.60 | 1.5831 | 59.46 |
| 22 | −10.0233 | 0.40 | 1.8433 | 42.70 |
| 23 | −18.3783 | 5.5893-10.6341-2.95 | | |
| 24 | 16.6273 | 2.07 | 1.4875 | 70.44 |
| 25 | −17.7782 | 0.40 | 1.9037 | 31.32 |
| 26 | 74.9664 | 0.45 | | |
| 27 | INF | 0.90 | 1.5168 | 64.20 |
| 28 | INF | | | |

TABLE 2

| No. | 0(EP) | 2(A) | 4(B) | 6(C) | 8(D) | 10(E) |
|---|---|---|---|---|---|---|
| 8 | 0.9281 | 0 | 5.0578E−07 | −7.4528E−07 | 1.8343E−08 | 6.9456E−10 |
| 16 | 1 | 0 | −6.6596E−05 | 8.4211E−07 | −5.9850E−08 | 1.2113E−09 |
| 17 | 1 | 0 | 5.7078E−05 | 1.1284E−06 | −6.3246E−08 | 1.3110E−09 |
| 21 | 1 | 0 | −4.4021E−05 | 9.6674E−07 | −3.6313E−08 | 6.1226E−10 |

TABLE 3

| No. | R | D | Nd | νd |
|---|---|---|---|---|
| 1 | 49.4667 | 0.90 | 1.8467 | 23.78 |
| 2 | 26.6975 | 4.39 | 1.4970 | 81.61 |
| 3 | −141.9904 | 0.15 | | |
| 4 | 23.1433 | 3.00 | 1.7725 | 49.62 |
| 5 | 68.5619 | 0.68-12.8906-20.6992 | | |
| 6 | 32.4003 | 0.50 | 1.8830 | 40.8 |
| 7 | 6.8611 | 0.20 | 1.5361 | 41.2 |
| 8 | 7.2012 | 3.51 | | |
| 9 | −11.9774 | 0.40 | 1.7725 | 49.62 |
| 10 | 27.2000 | 0.30 | | |
| 11 | 18.8861 | 1.49 | 1.9460 | 17.98 |
| 12 | −195.7838 | 20.7192-8.5085-0.7 | | |
| 13 | INF | 0.98 | | |
| 14 | INF | 0.78 | | |
| 15 | 10.6344 | 2.80 | 1.6935 | 53.2 |
| 16 | −38.8398 | 0.10 | | |
| 17 | 10.8731 | 3.06 | 1.4970 | 81.61 |
| 18 | −28.1112 | 0.40 | 1.8061 | 33.27 |
| 19 | 7.4636 | 8.2951-3.812-11.2453 | | |
| 20 | 14.3720 | 3.85 | 1.5831 | 59.46 |
| 21 | −8.9342 | 0.60 | 1.8830 | 40.8 |
| 22 | −15.6956 | 1.3832-1.4008-1.3859 | | |
| 23 | 15.8822 | 2.01 | 1.4875 | 70.44 |
| 24 | −17.0481 | 0.40 | 1.9037 | 31.32 |
| 25 | 39.4895 | 0.68 | | |
| 26 | INF | 0.90 | 1.5168 | 64.2 |
| 27 | INF | | | |

TABLE 4

| ASPH | 0(EP) | 2(A) | 4(B) | 6(C) | 8(D) | 10(E) |
|---|---|---|---|---|---|---|
| 9 | 1.6651E+00 | 0 | −1.4848E−04 | −1.2907E−05 | 6.3179E−07 | −2.2796E−08 |
| 16 | 1.0000E+00 | 0 | −6.6596E−05 | 8.4211E−07 | −5.9850E−08 | 1.2113E−09 |
| 17 | 1.0000E+00 | 0 | 5.2027E−05 | 3.5522E−07 | −3.1012E−08 | 8.9203E−10 |
| 21 | 1.0000E+00 | 0 | −4.0850E−05 | 4.1020E−07 | 2.7104E−10 | 4.3485E−11 |

TABLE 5

| No. | R | D | Nd | νd |
|---|---|---|---|---|
| 1 | 48.2532 | 0.9 | 1.84666 | 23.78 |
| 2 | 26.3041 | 4.3939 | 1.497 | 81.61 |
| 3 | −155.518 | 0.15 | | |
| 4 | 23.2259 | 3.0184 | 1.7725 | 49.62 |
| 5 | 70.4291 | 0.68-12.8199-20.6107 | | |
| 6 | 31.4074 | 0.5 | 1.883 | 40.8 |
| 7 | 6.8307 | 0.2 | 1.5361 | 41.2 |
| 8 | 7.1672 | 3.5078 | | |
| 9 | −11.9995 | 0.4 | 1.7725 | 49.62 |
| 10 | 26.9239 | 0.3 | | |
| 11 | 18.6845 | 1.4851 | 1.94595 | 17.98 |
| 12 | −220.793 | 20.6307-8.4908-0.7 | | |
| 13 | INF | 0.98 | | |
| 14 | INF | 0.78 | | |
| 15 | 10.6401 | 2.8003 | 1.6935 | 53.2 |
| 16 | −38.8302 | 0.1 | | |
| 17 | 11.0477 | 3.0822 | 1.497 | 81.61 |
| 18 | −27.5137 | 0.4 | 1.8061 | 33.27 |
| 19 | 7.5187 | 8.2423-3.758-11.4086 | | |
| 20 | 14.4581 | 3.867 | 1.58313 | 59.46 |
| 21 | −8.903 | 0.6 | 1.883 | 40.8 |
| 22 | −15.6009 | 6.4975-10.9818-3.3312 | | |
| 23 | 13.9223 | 2.0415 | 1.48749 | 70.44 |
| 24 | −20.0651 | 0.4 | 1.90366 | 31.32 |
| 25 | 29.2813 | 0.7434 | | |
| 26 | INF | 0.9 | 1.5168 | 64.2 |
| 27 | INF | | | |

TABLE 6

| No. | 0(EP) | 2(A) | 4(B) | 6(C) | 8(D) | 10(E) |
|---|---|---|---|---|---|---|
| 8 | 1.6472E+00 | 0 | −1.4522E−04 | −1.2646E−05 | 6.1436E−07 | −2.2023E−08 |
| 15 | 1.0000E+00 | 0 | −6.6596E−05 | 8.4211E−07 | −5.9850E−08 | 1.2113E−09 |
| 16 | 1.0000E+00 | 0 | 5.2124E−05 | 3.5647E−07 | −3.0829E−08 | 8.8528E−10 |
| 20 | 1.0000E+00 | 0 | −3.9894E−05 | 3.7442E−07 | 6.3674E−10 | 4.3018E−11 |

1. In a rear focusing zoom lens that is comprised of multi groups of lens pieces, namely, a leading or 1st lens group of positive refractivity, a 2nd lens group of negative refractivity, a 3rd lens group of positive refractivity, a 4th lens group of positive refractivity, and a 5th lens group of negative refractivity in this order on the closest to a photo-shot subject first basis where the 2nd lens group are moved along the optical axis from their respective position closer to the subject to an imaging plane so as to alter a variable power from the wide-angle end to the telephoto end while the 4th lens group are moved along the optical axis for the focusing;
the zoom lens satisfies the requirements as follows:
0<(DW−Δe34)/(z·DW)<0.09 Requirement Formula 1
0.3<|f2|/f3<0.4 Requirement Formula 2
where Δe34 is a varied amount of an interval between principal points of the 3rd and 4th lens groups at the telephoto end relative to that at the wide-angle end; Z is a zooming ratio, DW is a length of the entire optics, namely, between the foremost surface of the leading lens piece and the rearmost surface of the trailing lens piece, at the wide-angle end; f2 is a focal length of the 2nd lens group; and f3 is the focal length of the 3rd lens group.

2. In a rear focusing zoom lens that is comprised of multi groups of lens pieces, namely, a 1st lens group of positive refractivity, a 2nd lens group of negative refractivity, a 3rd lens group of positive refractivity, a 4th lens group of positive refractivity, and a 5th lens group of negative refractivity in this order from the closest to a photo-shot subject first basis where the 2nd lens group are moved along the optical axis from the subject to an imaging plane so as to alter a variable power from the wide-angle view to the telephoto view while the 4th lens group are moved along the optical axis for the focusing;
the zoom lens satisfies the requirements as follows:
0<(DW−Δe34)/(z·DW)<0.09 Requirement Formula 1
0.3<fW/f45W<0.4 Requirement Formula 3
where Δe34 is a varied amount of an interval between principal points of the 3rd and 4th lens groups at the telephoto end relative to that at the wide-angle end; Z is a zooming ratio, DW is a length of the entire optics, namely, between the front surface of the foremost lens piece and the rear surface of the rearmost lens piece, at the wide-angle end; fW is a focal length of the entire optics at the wide-angle end; and f45W is a synthesized focal length of the 4th and 5th lens groups at the wide-angle end.

3. In a rear focusing zoom lens that is comprised of multi groups of lens pieces, namely, a 1st lens group of positive refractivity, a 2nd lens group of negative refractivity, a 3rd lens group of positive refractivity, a 4th lens group of positive refractivity, and a 5th lens group of negative refractivity in this order on the closest to a photo-shot subject first basis where the 2nd lens group are moved along the optical axis from the subject to an imaging plane so as to alter a variable power from the wide-angle view to the telephoto view while the 4th lens group are moved along the optical axis for the focusing;
the zoom lens satisfies the requirements as follows:
0<(DW−Δe34)/(z·DW)<0.09 Requirement Formula 1
0.3<fW/f4<0.4 Requirement Formula 4
where Δe34 is a varied amount of an interval between principal points of the 3rd and 4th lens groups at the telephoto end relative to that at the wide-angle end; Z is a zooming ratio, DW is a length of the entire optics, namely, between the front surface of the foremost lens piece and the rear surface of the rearmost lens piece, at the wide-angle end; fW is a focal length of the entire optics at the wide-angle end; and f4 is a focal length of the 4th lens group.

4. The rear focusing zoom lens according to claim 1, wherein said 2nd lens group have one or more lens pieces that have a surface closer to the subject shaped in concave and the concave surface is aspherical.

5. The rear focusing zoom lens according to claim 1, wherein said 3rd lens group have one or more lens pieces that have a surface closer to the subject shaped in convex and the convex surface is aspherical.

6. The rear focusing zoom lens according to claim 1, wherein said 4th lens group have one or more lens pieces that have a surface closer to the subject shaped in convex and the convex surface is aspherical.

7. The rear focusing zoom lens according to claim 1, wherein while said 2nd lens group are moving along the optical axis, said 4th lens group are also moved along the optical axis so as to alter the variable power and fix the imaging plane in position.
